(19) United States
(12) Patent Application Publication
(10) Pub. No.: US 2023/0211356 A1
(43) Pub. Date: Jul. 6, 2023

(54) METHOD AND APPARATUS FOR ELECTROSTATIC WATER CONDENSATION OF WET AIR

(71) Applicant: SHUANGLIANG ECO-ENERGY SYSTEM CO., LTD., Jiangyin, Jiangsu (CN)

(72) Inventor: Qinzhen ZHENG, Wuxi, Jiangsu (CN)

(21) Appl. No.: 17/777,875

(22) PCT Filed: Sep. 10, 2020
(86) PCT No.: PCT/CN2020/114454

§ 371 Date: May 18, 2022

(30) Foreign Application Priority Data
Mar. 24, 2020 (CN) 202010210287.6

(51) Int. Cl. B03C 3/017; B03C 3/38; B03C 3/66

(52) U.S. Cl. CPC B03C 3/0175; B03C 3/38; B03C 3/66

(57) ABSTRACT

A method for electrostatic water condensation of wet air, comprising: a large number of positive and negative charges are respectively generated in two zones by means of positive and negative corona discharge; wet air enters independent positive and negative corona zones to cause water molecules to carry positive and negative charges, respectively; and after mixing, water molecules carrying positive and negative charges are attracted to each other and condense under the action of Coulomb force. An apparatus for electrostatic water condensation of wet air, comprising a trumpet-shaped inlet, an airflow distribution plate, a positive charge generator, a negative charge generator, a condenser, and a trumpet-shaped outlet, the condenser being disposed at the rear end of the positive charge generator and negative charge generator in the airflow direction. The method and apparatus for electrostatic water condensation of wet air can recycle water vapor while dehumidifying.

This application claims priority to Chinese Patent Application No. 202010210287.6, titled “METHOD AND APPARATUS FOR ELECTROSTATIC WATER CONDENSATION OF WET AIR”, filed on Mar. 24, 2020 with the China National Intellectual Property Administration, which is incorporated herein by reference in its entirety.

### FIELD

The present disclosure relates to a method and a device for electrostatically condensing wet air into water, and belongs to the field of electrostatic technology application.

### BACKGROUND

With the conventional technology, the humidity of ambient air seriously affects people’s life and production. In a humid environment, it is easy to breed bacteria and viruses which poses a serious threat to human health, and people who live in a humid environment for a long time may suffer from skin diseases, joint diseases and many other diseases. In production activities and industrial fields, the humid environment seriously interferes with operations of various production tools such as machines, instruments, and equipment. For example, in scientific research sites, industry sites, medical and health sites, instrumentation sites, commodity storage sites, underground engineering sites, and places such as computer rooms, archive rooms and warehouses, high humidity will cause instruments, computers, telecommunication equipment, medicines, and materials to be damp, rusted and mildewed, resulting in serious economic and property losses.

At present, the conventional dehumidification methods mainly include a heat exchange dehumidification method, a compression dehumidification method, a rotary disc dehumidification method, a liquid absorption dehumidification method, a solid adsorption dehumidification method, and the like. However, it is difficult to recycle water vapor in humid air with the conventional dehumidification methods. For example, with the rotary disc dehumidification method, water vapor in the humid air is transferred from one environment to another environment, having a poor dehumidification effect. With the liquid absorption method and the solid adsorption method, it is difficult to separate water vapor from an absorbent or adsorber, resulting in high dehumidification costs. Although the heat exchange dehumidification method and the compression dehumidification method have good dehumidification effect, it is difficult to recorver water vapor by using the two methods. For example, although white mist at an outlet of an industrial cooling tower can be can effectively eliminated by using the heat exchange dehumidification method, water cannot be saved. Therefore, it is required to provide a wet air dehumidification technology with which water vapor can be recycled.

Microscopically, gaseous water liquefaction is a process of shortening distances between gaseous water molecules, and electrostatic precipitation is a process of charging particles and then trapping the charged particles under an action of an electrostatic field. Therefore, based on the principle of electrostatic precipitation, water vapor in wet air may be realized in a high-voltage electrostatic field. In a Chinese patent with a publication number of CN2589860Y, an electrostatic condensation dehumidifier based on the principle of electrostatic precipitation is disclosed. The technical core of this patent is a high-voltage electrostatic generator, which includes a corona wire and a meshed water collecting plate. After a high voltage is applied between the corona wire and the meshed water collecting plate, moist air molecules are collected by the meshed water collecting plate under the action of high voltage static electricity and then condense into water. According to this patent, water molecules are regarded as micro particles, and it is expected that the water molecules are trapped and then condense into water in the high-voltage electrostatic field. However, in practical applications, it is found according to the patent that, only the mist droplets already present in wet air are collected and almost no water vapor is captured.

### SUMMARY

To solve the problems in the background technology, a method and a device for electrostatically condensing wet air into water are provided according to the present disclosure, applied to wet air conditions with large air volume and high humidity, operating continuously for a long time, and thereby achieving high efficiency, low cost, and safe and reliable operation.

According to the present disclosure, a method for electrostatically condensing wet air into water is provided. The method includes the following steps:
step 1, performing positive corona discharge to generate a large amount of positive charges in a positive corona zone, and performing negative corona discharge to generate a large amount of negative charges in a negative corona zone;
step 2, respectively feeding wet air to the positive corona zone and the negative corona zone, where water molecules in the positive corona zone carry the positive charges and water molecules in the negative corona zone carry the negative charges;
step 3, mixing the wet air in the positive corona zone and the wet air in the negative corona zone together, where the water molecules carrying the positive charges and the water molecules carrying the negative charges attract each other and condense into water under an action of an electrostatic field.

In step 1, the positive corona discharge is driven by a positive high-voltage direct current power supply, and the negative corona discharge is driven by a negative high-voltage direct current power supply.

The corona zone is a region in which corona discharge is performed. In the corona zone, air is ionized to generate a large amount of ionic charges, providing a charge source for charging the water molecules.

A device for electrostatically condensing wet air into water is provided. The device includes an inlet bell mouth, an airflow distribution plate, a positive charge generator, a negative charge generator, a condenser and an outlet bell mouth. The device is arranged with a shell, and the shell is grounded. The inlet bell mouth and the outlet bell mouth are respectively arranged at two sides of the shell. The airflow distribution plate is arranged at an inlet end of the inlet bell mouth. The positive charge generator and the negative charge generator are arranged side by side, and are arranged at a rear end of the airflow distribution plate along an airflow direction. The positive charge generator and the negative charge generator respectively generate the positive charges and the negative charges, and provide passages for saturated wet air to flow through. The positive charge generator and the negative charge generator are in-situ charging devices for water molecules without an input from a charge source, simplfying structural arrangement and effectively reducing a volume of the device. The condenser is arranged at rear ends of the positive charge generator and the negative charge generator along the airflow direction.

The positive charge generator is configured to be driven by a positive high-voltage direct current power supply, and the negative charge generator is configured to be driven by a negative high-voltage direct current power supply.

The positive high-voltage direct current power supply is configured to drive multiple anode wires, and the negative high-voltage direct current power supply is configured to drive multiple cathode wires.

The positive charge generator is in a rectangular parallelepiped shape, and includes a positive charge generator shell, a plate electrode, an anode wire, and a positive high-voltage direct current power supply. The positive charge generator shell is connected to a low voltage terminal of the positive high-voltage direct current power source and is grounded. The anode wire is arranged at a center of the positive charge generator along the airflow direction, and is connected to a high voltage terminal of the positive high-voltage direct current power supply. The negative charge generator is in a rectangular parallelepiped shape, includes a negative charge generator shell, a cathode wire, and a negative high-voltage direct current power supply, and is configured to share the plate electrode with the positive charge generator. The plate electrode is connected to the positive charge generator shell and the negative charge generator shell. The negative charge generator shell is connected to a low voltage terminal of the negative high-voltage direct current power supply, and is grounded. The cathode wire is arranged at a center of the negative charge generator along the airflow direction, and is connected to a high voltage terminal of the negative high-voltage direct current power supply. The positive charge generator shell is in direct contact with the negative charge generator shell.

The condenser includes a first condensing mesh and a second condensing mesh that are arranged in the shell. The first condensing mesh is configured to have a central axis coinciding with a plate electrode in a horizontal direction, and to have a length in a vertical direction equal to a distance between an anode wire and a cathode wire. The second condensing mesh is configured to have an area equal to a cross-sectional area of the integral shell. Both the first condensing mesh and the second condensing mesh are directly connected to a positive charge generator shell and a negative charge generator shell, and are grounded.

With the device for electrostatically condensing wet air into water according to the present disclosure, and wet air evenly flows through the positive charge generator and the negative charge generator. Then, air molecules in the wet air are ionized to generate a large number of positive charges and negative charges, and the positive charges and the negative charges are captured by water molecules. The water molecules carrying different charges are fully mixed in a mixer to condense into water, and grounded condensing meshes are used for further promoting the condensation of charged water molecules. The condensed water is drained from the inlet bell mouth under the action of gravity. Based on the above operations, the water vapor in the wet air is condensed into water and recovered.

Compared with the conventional technology, the method and the device for electrostatically condensing wet air into water according to the present disclosure have the following advantages.

1. Small size, small footprint, easy construction and installation, low construction and operation cost, and high efficiency can be achieved.

2. Dry air in wet air is used as a charge source for condensing water vapor into water without an external charge source.

3. A condensation effect more than ten times higher than a condensation effect of electrostatic condensation using same charges and a high condensation efficiency can be achieved.

4. Continuous operation for a long time, low discharge output voltage, safe and stable operation can be achieved.

5. The method and the device according to the present disclosure can be applied for wet air having a wide range of temperature and a wide range of humidity.

6. It is easy to use multiple groups of positive charge generators and negative charge generators together, and the cost of construction and operation of the method and the device according to the present disclosure is far lower than the cost of construction and operation of the conventional large-scale air dehumidifiers.

### BRIEF DESCRIPTION OF THE DRAWINGS

FIG. 1 is a schematic top view of a device for electrostatically condensing wet air into water according to the present disclosure.

FIG. 2 is a schematic elevational view of a device for electrostatically condensing wet air into water according to the present disclosure.

FIG. 3 are schematic side views of a positive charge generator and a negative charge generator in a device for electrostatically condensing wet air into water according to the present disclosure.

FIG. 4 are schematic side views of condensing meshes in a device for electrostatically condensing wet air into water according to the present disclosure.

FIG. 5 are schematic side views of a positive charge generator and a negative charge generator in a device for electrostatically condensing wet air into water according to another embodiment of the present disclosure.

Reference numbers are listed as follows:

| | |
|---|---|
| 1 | Inlet bell mouth |
| 2 | Airflow distribution plate |
| 3 | Positive charge generator |
| 3.1 | Anode wire |
| 3.2 | Positive charge generator shell |
| 3.3 | Positive high-voltage direct current power supply |
| 3.4 | Plate electrode |
| 4 | Negative Charge generator |
| 4.1 | Cathode wire |
| 4.2 | Negative charge generator shell |
| 4.3 | Negative high-voltage direct current power supply |
| 5 | Condenser |
| 5.1 | First condensing mesh |
| 5.2 | Second condensing mesh |
| 6 | Outlet bell mouth |

### DETAILED DESCRIPTION

The present disclosure is described below in conjunction with the accompanying drawings and specific embodiments.

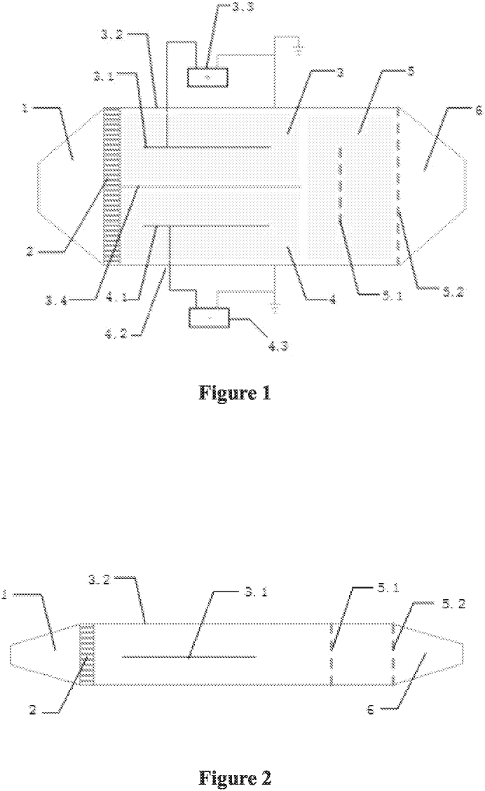

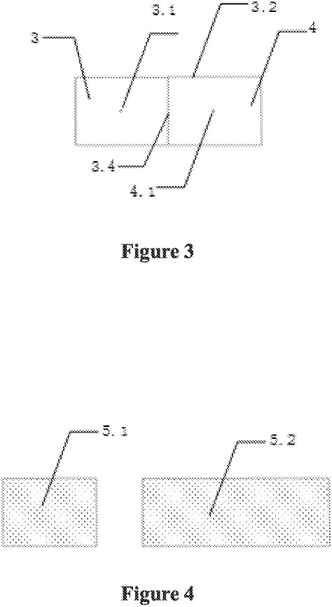

As shown in FIG. 1 to FIG. 4, a device for electrostatically condensing wet air into water includes an inlet bell mouth 1, an airflow distribution plate 2, a positive charge generator 3, a negative charge generator 4, a condenser 5 and an outlet bell mouth 6. The device is arranged with a shell, and the shell is grounded. The inlet bell mouth 1 and the outlet bell mouth 6 are respectively arranged at two sides of the shell. The airflow distribution plate 2 is arranged at an inlet end of the inlet bell mouth 1. The positive charge generator 3 and the negative charge generator 4 are arranged side by side, and are arranged at a rear end of the airflow distribution plate 2 along an airflow direction. The condenser 5 is arranged at rear ends of the positive charge generator 3 and the negative charge generator 4 along the airflow direction.

In the embodiment, the inlet bell mouth 1 is an air inlet for the wet air. A ratio of a flow area of a contraction end of the inlet bell mouth 1 to a flow area of an expansion end of the inlet bell mouth 1 is less than or equal to 1 to 4. The inlet bell mouth 1 has a slope less than or equal to 45, and is made of stainless steel.

The airflow distribution plate 2 is arranged at the expansion end of the inlet bell mouth 1. A resistance caused by the airflow distribution plate 2 is less than or equal to 20 Pa. The airflow distribution plate 2 is made of polytetrafluoroethylene, which is hydrophobic and does not easily cause accumulation of condensed water.

In the embodiment, the positive charge generator 3 and the negative charge generator 4 are arranged side by side, and are arranged at a rear end of the airflow distribution plate 2. The positive charge generator and the negative charge generator respectively generate the positive charges and the negative charges, and provide passages for saturated wet air to flow through. The positive charge generator and the negative charge generator are in-situ charging devices for water molecules without connecting to a charge source, simplfying structural arrangement and effectively reducing the volume of the device.

The positive charge generator 3 is driven by a positive high-voltage direct current power supply 3.3. The negative charge generator 4 is driven by a negative high-voltage direct current power supply 4.3.

The positive high-voltage direct current power supply 3.3 drives multiple anode wires 3.1. The negative high-voltage direct current power supply 4.3 drives multiple cathode wires 4.1.

The positive charge generator 3 is in a rectangular parallelepiped shape, and includes a positive charge generator shell 3.2, a plate electrode 3.4, an anode wire 3.1, and a positive high-voltage direct current power supply 3.3. The positive charge generator shell 3.2 is connected to a low voltage terminal of the positive high-voltage direct current power supply 3.3, and is grounded. The anode wire 3.1 is arranged at a center of the positive charge generator 3 along the airflow direction, and is connected to a high voltage terminal of the positive high-voltage direct current power supply 3.3. The negative charge generator 4 is in a rectangular parallelepiped shape, and includes a negative charge generator shell 4.2, a cathode wire 4.1, and a negative high-voltage direct current power supply 4.3. The negative charge generator 4 shares the plate electrode 3.4 with the positive charge generator 3. The plate electrode 3.4 is connected with the positive charge generator shell 3.2 and the negative charge generator shell 4.2. The negative charge generator shell 4.2 is connected to a low voltage terminal of the negative high-voltage direct current power supply 4.3, and is grounded. The cathode wire 4.1 is arranged at a center of the negative charge generator 4 along the airflow direction, and is connected to a high voltage terminal of the negative high-voltage direct current power supply 4.3. The positive charge generator shell 3.2 is in direct contact with the negative charge generator shell 4.2.

In an embodiment, the positive charge generator shell 3.2 may serve as a rectangular airflow passage, having a size of a*a*b, formed by four rectangular stainless steel flat plates each of which having a size of a*b. The positive charge generator shell 3.2 is connected to a ground terminal of the positive high-voltage direct current power supply 3.3 via a metal wire. The rectangular airflow passage is easy to be installed, and is easy to be seamlessly connected to the inlet bell mouth 1 and the outlet bell mouth 6. The anode wire 3.1 is a stainless steel wire having a diameter less than or equal to 1 mm. The anode wire 3.1 is arranged at a center of the rectangular airflow passage along the airflow direction, and is connected to a high voltage terminal of the positive high-voltage direct current power supply 3.3 via a metal wire.

In an embodiment, the negative charge generator shell 4.2 may serve as a rectangular airflow passage, having a size of a*a*b, formed by four rectangular stainless steel flat plates each of which having a size of a*b. The negative charge generator shell 4.2 is connected to a ground terminal of the negative high-voltage direct current power supply 4.3 via a metal wire. The rectangular airflow passage is easy to be installed, and is easy to be seamlessly connected to the inlet bell mouth and the outlet bell mouth. The cathode wire 4.1 is a stainless steel wire having a diameter less than or equal to 1 mm. The cathode wire 4.1 is arranged at a center of the rectangular airflow passage along the airflow direction, and is connected to a high voltage terminal of the negative high-voltage direct current power supply 4.3 via a metal wire.

In an embodiment, the number of ions after corona discharge is much greater than the number of water molecules in the wet air, so that the number of ions is sufficient for charging the water molecules. Preferably, in order to improve the utilization rate of electric energy, for the positive high-voltage direct current power supply 3.3, an output voltage is greater than or equal to 10 kV, an output current is greater than or equal to 2 mA, and an output frequency ranges from 50 Hz to 300 Hz; and for the negative high-voltage direct current power supply 4.3, an output voltage is greater than or equal to 15 kV, an output current is greater than or equal to 2 mA, and an output frequency ranges from 50 Hz to 300 Hz. In a case of maintaining a low output current, the output voltage is reduced accordingly, reducing power consumption, achieving a high use safety, reducing a reduced insulation requirement, reducing safety distance, and achieving high space utilization.

In an embodiment, the plate electrode 3.4 shared by the positive charge generator 3 and the negative charge generator 4 is a rectangular stainless steel plate having a size of a*b, where 50 mm≤a≤100 mm.

In a case of a<50 mm, it is easy to cause spark discharge between a plate electrode and a wire electrode, resulting in an unstable operation. In a case of a>100 mm, a distance between the plate electrode and the wire electrode is increased and it is difficult to discharge, thus it is required to increase of the output voltage to implement, increasing the power consumption and the instability of operation.

For the rectangular stainless steel plate, 2a≤b≤4a. b is set to be great than or equal to 2a to ensure sufficient ionization of the air, so that the water molecules are fully charged; and b is set to be less than or equal to 4a to prevent the charged water molecules from being trapped by the plate electrode to loss charges and to save equipment cost.

The condenser 5 includes a first condensing mesh 5.1 and a second condensing mesh 5.2 that are arranged in the shell. The first condensing mesh 5.1 has a central axis coinciding with the plate electrode 3.4 in a horizontal direction, and has a length in a vertical direction equal to a distance between the anode wire 3.1 and the cathode wire 4.1. The second condensing mesh 5.2 has an area equal to a cross-sectional area of the shell. Both the first condensing mesh and the second condensing mesh are directly connected to the positive charge generator shell 3.2 and the negative charge generator shell 4.2, and are grounded.

In an embodiment, the first condensing mesh 5.1 and the second condensing mesh 5.2 are stainless steel metal meshes and connected to the shell. Each of the first condensing mesh 5.1 and the second condensing mesh 5.2 has a mesh number of 300, and is arranged along the airflow direction.

In an embodiment, in order to ensure successfully performing corona discharge and generating sufficient ionic charges by the charge generators, the temperature of the wet air is set to be lower than or equal to 95° C. In a case of using a group of positive and negative charge generators, a total flow of the wet air is less than or equal to 3.6ab*10-3 m3/h.

In order to increase a processing flow of the wet air, n groups of positive and negative charge generators may be used simultaneously according to the present disclosure. With multiple groups of positive and negative charge generators, turbulent intensity of charged water molecules in a mixer may be enhanced to promote condensation. Using n groups of positive and negative charge generators, a condensation amount S is much greater than n*a, where a represents a condensation amount in a case of using one group of positive and negative charge generators.

A method for electrostatically condensing wet air into water is provided. The method includes the following steps 1 to 3.

In step 1, positive corona discharge is performed to generate a large amount of positive charges in an independent positive corona zone, and negative corona discharge is performed to generate a large amount of negative charges in an independent negative corona zone.

In step 2, wet air is respectively fed to the positive polarity corona zone and the negative polarity corona zone, so that water molecules in the positive corona zone carry the positive charges and water molecules in the negative corona zone carry the negative charges.

In step 3, the wet air from the positive corona zone and the wet air from the negative corona zone are mixed together, so that the water molecules carrying the positive charges and the water molecules carrying the negative charges attract each other and condense into water under an action of an electrostatic field.

The corona zone is a region in which corona discharge is performed. In the corona zone, air is ionized to generate a large amount of ionic charges, providing a charge source for charging the water molecules.

The positive corona discharge is driven by a positive high-voltage direct current power supply, and the negative corona discharge is driven by a negative high-voltage direct current power supply.

In an embodiment, in order to ensure that the content of water molecules in the wet air fed to the positive polarity corona zone is the same as the content of water molecules in the wet air fed to the negative polarity corona zone, airflow structure optimization is performed on the wet air before the wet air is respectively fed to the positive corona zone and the negative corona zone. A root mean square δ of the speed of the airflow at an inlet section of each of the two corona zones is less than or equal to 0.15.

In order to prevent unstable phenomena such as creepage and short circuit of a power supply due to the accumulation of condensed water and recover the condensed water, an angle between the airflow direction and a horizontal plane is greater than or equal to 75°.

In the embodiment, the method for electrostatically condensing wet air into water in the present disclosure is performed by starting up the device described above. After turning on the positive high-voltage direct current power supply 3.3 and the negative high-voltage direct current power supply 4.3, the positive charge generator 3 generates a large number of positive charges and the negative charge generator 4 generates a large number of negative charges. The wet air is fed to the inlet bell mouth 1, and then is evenly fed to the positive charge generator 3 and to the negative charge generator 4 through the airflow distribution plate 2.

The water molecules in the wet air fed to the positive charge generator 3 is charged with positive charges, and the water molecules in the wet air fed to the negative charge generator 4 is charged with negative charges. Then, the wet air from the positive corona zone and the wet air from the negative corona zone are fed to the condenser 5. Since the first condensing mesh 5.1 and the second condensing mesh 5.2 are grounded and at a zero potential, an electrostatic field is formed with the anode wire 3.1 and the cathode wire 4.1, thereby driving the charged water molecules to gather on the two condensing meshes. The water molecules carrying the positive charges and the water molecules carrying the negative charges gathered on the condensing meshes attract each other and condense into water, realizing electrostatic condensation of wet air.

In an embodiment, in a case that the positive charge generator 3 and the negative charge generator 4 are turned off, saturated wet air, having a volume flow of 5 L/min and a dry bulb temperature of 85° C., is fed to the device for electrostatically condensing wet air into water according to the present disclosure, then 300 ml condensed water is obtained after one hour by natural condensation; and in a case that the positive charge generator 3 and negative charge generator 4 are turned on, the positive high-voltage direct current power supply 3.3 operates with an output voltage of 10 kV, an output current of 2 mA and an output frequency of 50 Hz, and the negative high-voltage direct current power supply 4.2 operates with an output voltage of 15 kV, an output current of 2 mA and an output frequency of 50 Hz, 1100 ml condensed water is obtained after one hour, and a yield of condensed water per unit energy consumption is 16 ml/W.

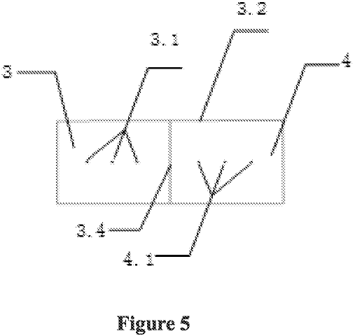

In a second embodiment, as shown in FIG. 5, the embodiment is different from the first embodiment in that N anode wires 3.1 are arranged in the positive charge generator 3 and N cathode wires 4.1 are arranged in the negative charge generator 4. The N anode wires 3.1 are connected in parallel with a high voltage terminal of the positive high-voltage direct current power supply 3.3. The N cathode wires 4.1 are connected in parallel with a high voltage terminal of the negative high-voltage direct current power supply 4.3.

According to the embodiment, the following advantages can be achieved. The positive charge generator 3 and the negative charge generator 4 operate at a higher power, thereby improving the processing flow of the wet air and improving the yield of condensed water per unit of energy consumption.

Other technical features and technical solutions according to the second embodiment are the same as those technical features and technical solutions according to the first embodiment.

The above embodiments are only specific application examples of the present disclosure, and are not intended to limit the protection scope of the present disclosure. Any other technical solutions obtained by equivalent transformation or equivalent substitution should fall within the protection scope of the present disclosure.

1. A method for electrostatically condensing wet air into water, comprising:
step 1, performing positive corona discharge to generate a large amount of positive charges in a positive corona zone, and performing negative corona discharge to generate a large amount of negative charges in a negative corona zone;
step 2, respectively feeding wet air to the positive corona zone and the negative corona zone, wherein water molecules in the positive corona zone carry the positive charges and water molecules in the negative corona zone carry the negative charges;
step 3, mixing the wet air from the positive corona zone and the wet air from the negative corona zone together, wherein the water molecules carrying the positive charges and the water molecules carrying the negative charges attract each other and condense into water under an action of an electrostatic field.

2. The method for electrostatically condensing wet air into water according to claim 1, wherein the positive corona discharge is driven by a positive high-voltage direct current power supply and the negative corona discharge is driven by a negative high-voltage direct current power supply.

3. A device for electrostatically condensing wet air into water, comprising an inlet bell mouth, an airflow distribution plate, a positive charge generator, a negative charge generator, a condenser, and an outlet bell mouth, wherein
the device is arranged with a shell, and the shell is grounded;
the inlet bell mouth and the outlet bell mouth are respectively arranged at two sides of the shell;
the airflow distribution plate is arranged at an inlet end of the inlet bell mouth;
the positive charge generator and the negative charge generator are arranged side by side, and are arranged at a rear end of the airflow distribution plate along an airflow direction; and
the condenser is arranged at rear ends of the positive charge generator and the negative charge generator along the airflow direction.

4. The device for electrostatically condensing wet air into water according to claim 3, wherein the positive charge generator is configured to be driven by a positive high-voltage direct current power supply, and the negative charge generator is configured to be driven by a negative high-voltage direct current power supply.

5. The device for electrostatically condensing wet air into water according to claim 4, wherein the positive high-voltage direct current power supply is configured to drive a plurality of anode wires, and the negative high-voltage direct current power supply is configured to drive a plurality of cathode wires.

6. The device for electrostatically condensing wet air into water according to claim 3, wherein the positive charge generator is in a rectangular parallelepiped shape, and comprises a positive charge generator shell, a plate electrode, an anode wire, and a positive high-voltage direct current power supply;
the positive charge generator shell is connected to a low voltage terminal of the positive high-voltage direct current power source and is grounded;
the anode wire is arranged at a center of the positive charge generator along the airflow direction, and is connected to a high voltage terminal of the positive high-voltage direct current power supply;
the negative charge generator is in a rectangular parallelepiped shape, comprises a negative charge generator shell, a cathode wire, and a negative high-voltage direct current power supply, and is configured to share the plate electrode with the positive charge generator;
the plate electrode is connected to the positive charge generator shell and the negative charge generator shell;
the negative charge generator shell is connected to a low voltage terminal of the negative high-voltage direct current power supply and is grounded;
the cathode wire is arranged at a center of the negative charge generator along the airflow direction, and is connected to a high voltage terminal of the negative high-voltage direct current power supply; and
the positive charge generator shell is in direct contact with the negative charge generator shell.

7. The device for electrostatically condensing wet air into water according to claim 3, wherein the condenser comprises a first condensing mesh and a second condensing mesh that are arranged in the shell;
the first condensing mesh is configured to have a central axis coinciding with a plate electrode in a horizontal direction and to have a length in a vertical direction equal to a distance between an anode wire and a cathode wire;
the second condensing mesh is configured to have an area equal to a cross-sectional area of the shell; and
both the first condensing mesh and the second condensing mesh are directly connected to a positive charge generator shell and a negative charge generator shell, and are grounded.
